(19) United States
(12) Patent Application Publication
(10) Pub. No.: US 2005/0066705 A1
(43) Pub. Date: Mar. 31, 2005

(54) Arm assembly for a crash test dummy

(76) Inventor: Seong Chull Choi, Gunpo-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/750,686

(22) Filed: Dec. 31, 2003

(30) Foreign Application Priority Data
Sep. 25, 2003 (KR) 10-2003-0066538

(51) Int. Cl. G01N 3/00

(52) U.S. Cl. 73/12.09

(57) ABSTRACT

An arm assembly for a crash test dummy includes an upper arm unit, a lower arm unit, a wrist joint, and a hand unit. An upper portion of the upper arm unit is connected to a body of the crash test dummy. The lower arm unit is pivotally connected to a lower portion of the upper arm unit. A first end of the wrist joint is rotatably connected to the lower arm unit. The hand unit is pivotally connected to a second end of the wrist joint. The upper arm unit comprises a housing and a driving device disposed in the housing. The driving device drives the lower arm unit.

### CROSS-REFERENCE TO RELATED APPLICATIONS

This application claims priority of Korean Application No. 10-2003-0066538, filed on Sep. 25, 2003, the disclosure of which is incorporated fully herein by reference.

### FIELD OF THE INVENTION

Generally, the present invention relates to an automobile crash test dummy. More particularly, the crash test dummy includes a novel arm assembly for a crash test dummy.

### BACKGROUND OF THE INVENTION

Crash test dummies are widely used in vehicle crash tests to simulate injury to an occupant. A conventional arm assembly of a crash test dummy includes an upper arm portion, a lower arm portion, and a hand portion. These portions are generally connected together through universal joints. Such a conventional arm assembly cannot accurately realize a force of a human arm, therefore, results of the test are not always accurate.

Furthermore, fingers of the hand unit are generally fixed to a steering wheel with a fixing means such as tape during a vehicle crash. Because the fingers of the dummy are fixed to the wheel, it is difficult to simulate accurate results of an injury to a living occupant because the fingers do not realize a grasping force of a human hand.

The information disclosed in this Background of the Invention section is only for enhancement of understanding of the background of the invention, and should not be taken as an acknowledgement or any form of suggestion that this information forms prior art already known to a person skilled in the art.

### SUMMARY OF THE INVENTION

An embodiment of the present invention provides an arm assembly of a crash test dummy that acts similarly to a human arm. In a preferred embodiment, an arm assembly for a crash test dummy comprises an upper arm unit, a lower arm unit, a wrist joint, and a hand unit. An upper portion of the upper arm unit is connected to a body of the crash test dummy and the lower arm unit is pivotally connected to a lower portion of the upper arm unit. A first end of the wrist joint is rotatably connected to the lower arm unit, while the hand unit is pivotally connected to a second end of the wrist joint. The upper arm unit comprises a housing. A driving device is disposed in the housing and drives the lower arm unit.

It is preferable that the driving device comprises a motor and a gear unit. The gear unit is driven by the motor and it is configured to drive the lower arm unit to undergo pivotal motions.

In another preferred embodiment, an arm assembly for a crash test dummy comprises an upper arm unit, a lower arm unit, a wrist joint, and a hand unit. An upper portion of the upper arm unit is connected to a body of the crash test dummy. The lower arm unit is pivotally connected to a lower end portion of the upper arm unit. A first end of the wrist joint is rotatably connected to the lower arm unit, while the hand unit is pivotally connected to a second end of the wrist joint. The hand unit is configured to grasp a steering wheel of a vehicle and to be separated from the steering wheel by a force.

It is preferable that the hand unit comprises a first plate, a second plate, a first connecting rod, a second connecting rod, a first finger unit, a second finger unit, and an elastic member. The first and second plates are disposed to face each other. The first connecting rod is coupled, respectively, to the first and second plates, and the wrist joint is pivotally connected to the first connecting rod. The second connecting rod is coupled, respectively, to the first and second plates such that the second connecting rod restricts pivotal motions of the wrist joint with respect to the first connecting rod. The first finger unit is pivotally coupled to the first and second plates. The second finger unit is pivotally coupled to the first and second plates. The second finger unit is connected to the first finger unit such that the second finger unit moves together with the first finger unit. The elastic member biases the first finger unit so that the first finger unit and the second finger unit are in a grasping state.

It is preferable that the hand unit further comprises a third connecting rod connected, respectively, to the first and second plates such that the third connecting rod restricts a pivotal motion of the first finger unit.

Preferably, the hand unit further comprises a fourth connecting rod connected, respectively, to the first and second plates such that the fourth connecting rod restricts a pivotal motion of the second finger unit.

It is further preferable that the elastic member is a coil spring.

In another preferred embodiment, an arm assembly for a crash test dummy comprises an upper arm unit, a lower arm unit, a wrist joint, and a hand unit. The upper arm unit is connected to a body of the crash test dummy and the lower arm unit is pivotally connected to a lower portion of the upper arm unit. A first end of the wrist joint is rotatably connected to the lower arm unit, while the hand unit is rotatably connected to a second end of the wrist joint. The upper arm comprises a housing and a driving device. The driving device is disposed in the housing and drives the lower arm unit. The hand unit is configured to grasp a steering wheel of a vehicle and to be separated from the steering wheel by a force.

It is further preferable that the driving device comprises a motor and a gear unit that is driven by the motor. The gear unit is configured to drive the lower arm unit to undergo pivotal motions.

In yet another preferred embodiment, an arm assembly for a crash test dummy comprises an upper arm unit, a lower arm unit, a hand unit, and a wrist joint. The upper arm is connected to a body of the crash test dummy and the lower arm unit is pivotally connected to a lower portion of the upper arm unit. The wrist joint connects the lower arm unit and the hand unit together. A circular recession is formed on an outer periphery of a first end portion of the wrist joint, a cylindrical recession is formed in the lower arm unit, and a circular protrusion is formed along an inner periphery of the cylindrical recession. The first end of the wrist joint is inserted into the cylindrical recession such that the circular recession is fitted to the circular protrusion.

It is preferable that the hand unit comprises a first plate and a second plate that are disposed to face each other. A circular plate has a through hole formed in a center portion thereof is provided in a second end of the wrist joint and the circular plate is disposed between the first and second plates. The circular plate is connected to the first and second plates through a connecting rod that is rotatably inserted into the through hole.

It is further preferable that a friction member is disposed between the circular plate of the wrist joint and the first and second plates of the hand unit.

### BRIEF DESCRIPTION OF THE DRAWINGS

The accompanying drawings, which are incorporated in and constitute a part of the specification, illustrate an embodiment of the invention, and, read together with the description, serve to explain the principles of the invention, where:

FIG. 1 shows a crash test dummy including an arm assembly according to an embodiment of the present invention;

FIG. 2 shows an arm assembly according to an embodiment of the present invention;

FIG. 3 schematically shows a driving device for driving a lower arm unit of the arm assembly according to an embodiment of the present invention;

FIGS. 4 and 5 show a hand unit of the arm assembly according to an embodiment of the present invention; and

FIG. 6 shows a connection between a wrist joint and the hand unit according to an embodiment of the present invention.

### DETAILED DESCRIPTION OF A PREFERRED EMBODIMENT

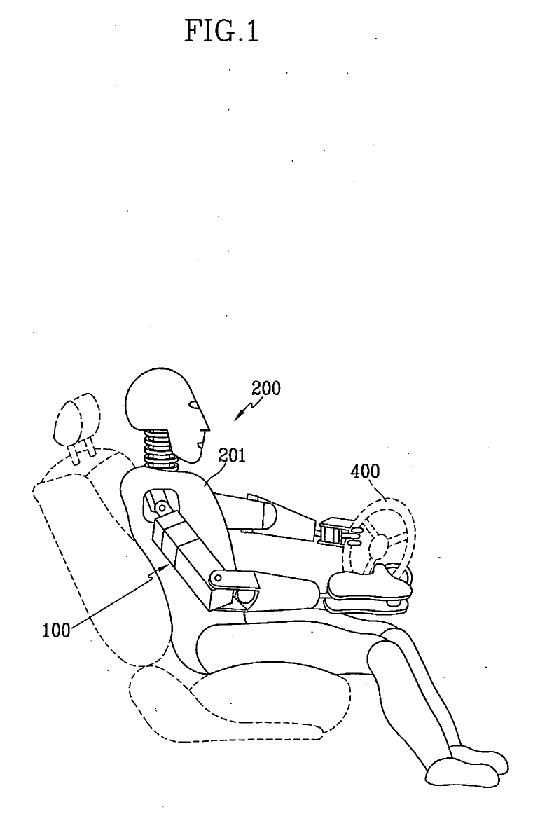

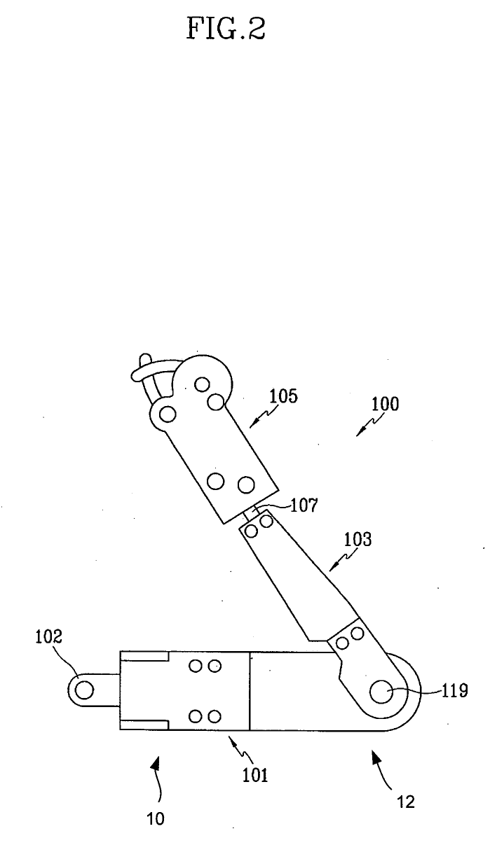

As shown in FIGS. 1 and 2, an arm assembly 100 for a crash test dummy 200 includes an upper arm unit 101 and a lower arm unit 103. An upper end portion 10 of the upper arm unit 101 is pivotally connected to a body 201 of the crash test dummy 200 through a link portion 102. Preferably, a pivotal motion of the upper arm unit 101 with respect to the body 201 of the crash test dummy 200 is allowed within a predetermined range. The lower arm unit 103 is pivotally connected to a lower end portion 12 of the upper arm unit 101. A hand unit 105 is connected to the lower arm unit 103 through a wrist joint 107.

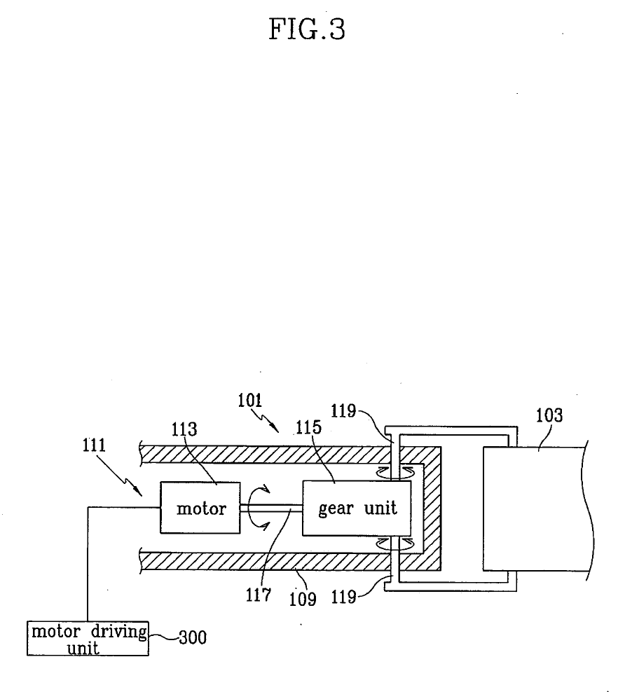

According to FIG. 3, the upper arm unit 101 includes a housing 109 and a driving device 111. The driving device 111 is disposed inside the housing 109 and the driving device 111 drives the lower arm unit 103 to undergo pivotal motions. It is preferable that the driving device 111 includes a motor 113 and a gear unit 115 connected to the motor 113. The motor 113 is controlled by a motor driving unit 300. For example, the motor 113 can be a DC motor. The motor driving unit 300 may include a power source, an interface, a controller, or the like. The gear unit 115 can be any device that can receive a rotational force from the motor 113 and reduce a rotational speed. The gear unit 115 rotates a rotating shaft 119, thereby causing the lower arm unit to rotate. For example, the gear unit 115 can be a right angle type “NR34” (reducing ratio 100:1) that is made by BAYSIDE MOTION GROUP®. Within the arm assembly 100, the lower arm unit 103 is driven by the motor 113 and the gear unit 115 during a crash test, so that an active force of a human arm can be realized.

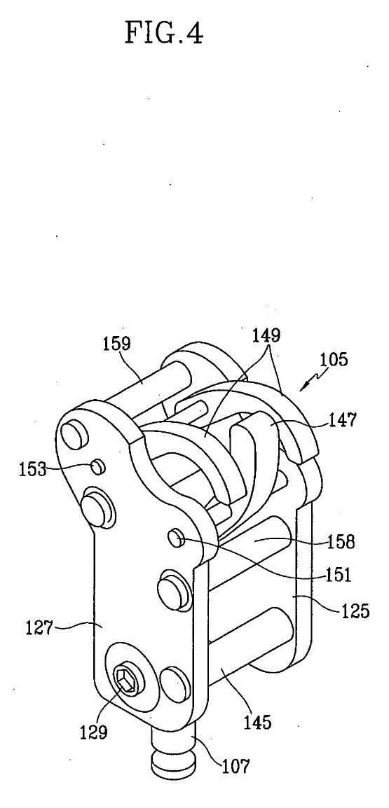

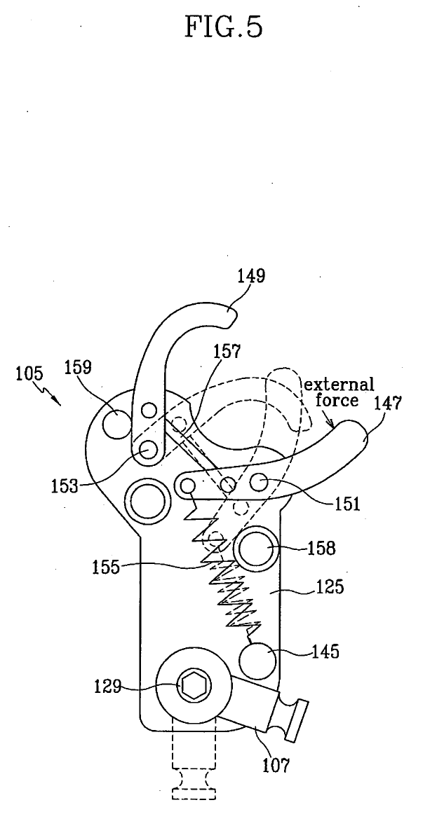

As shown in FIGS. 4 and 5, the hand unit 105 includes a first plate 125 and a second plate 127. Both plates 125 and 127 are disposed to face each other with a predetermined distance therebetween. A first connecting rod 129 is connected, respectively, to the first and second plates 125 and 127 and the wrist joint 107 is pivotally connected thereto. As an example, the first connecting rod 129 can be a bolt.

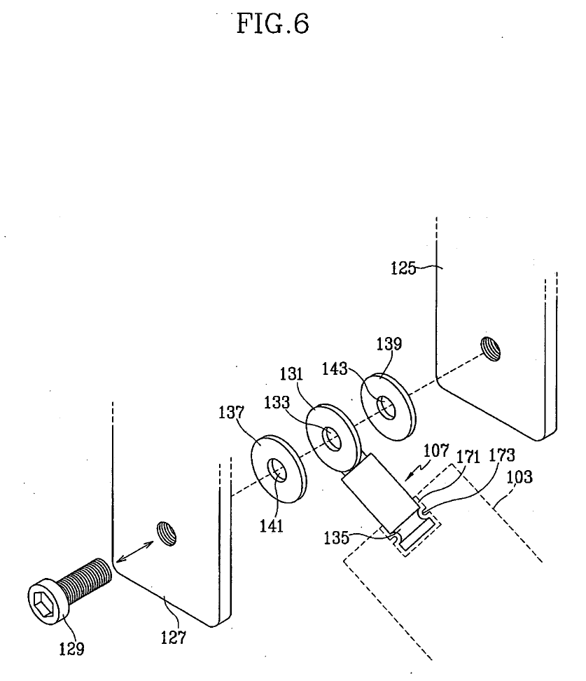

As shown in FIG. 6, a circular plate 131 is provided in one end portion of the wrist joint 107 and a through hole 133 is formed in a center portion of the circular plate 131. The first connecting rod 129 is inserted in the through hole 133 so the hand unit 105 is pivotally connected to the wrist joint 107. A circular recession 135 is formed on an outer periphery of the other end of the wrist joint 107 and the wrist joint 107 is rotatably connected to the lower arm unit 103 by way of the circular recession 135.

As shown in FIG. 6, the wrist joint 107 is inserted in a cylindrical recession 171 formed in the lower arm unit 103. A circular protrusion 173 is formed on an inner periphery of the cylindrical recession 171. The wrist joint 107 is disposed in the cylindrical recession 171 of the lower arm unit 10 such that the circular protrusion 173 is fitted into the circular recession 135. Accordingly, the wrist joint 107 is rotatably connected to the lower arm unit 103.

Friction members 137 and 139 are disposed on both sides of the circular plate 131. Through holes 141 and 143 are formed, respectively, to the friction members 137 and 139 and the first connecting rod 129 is inserted into the through holes 141 and 143. By rotating the first connecting rod 129, friction forces between the circular plate 131 and the friction members 137 and 139 can be adjusted.

Referring back to FIG. 5, a second connecting rod 145 is provided near the first connecting rod 129, such that the second connecting rod 145 can restrict a pivot motion (counter-clockwise rotation) of the wrist joint 107. The second connecting rod 145 is connected, respectively, to the first and second plates 125 and 127. The hand unit 105 includes a first finger 147 and a pair of second fingers 149, which correspond to fingers of a human hand. The first finger 147 is pivotally connected to a connecting rod 151 that is connected, respectively, to the first and second plates 125 and 127. Similarly, the second finger 149 is pivotally connected to a connecting rod 153 that is connected, respectively, to the first and second plates 125 and 127.

A first end of an elastic member 155 is connected to the first finger 147, and a second end of the elastic member 155 is connected to the second connecting rod 145. As an example, the elastic member 155 can be a coil spring. The first finger 147 and the second finger 149 are connected to each other through a connecting member 157. One end of the connecting member 157 is pivotally connected to the first finger 147 and the other end of the connecting member 157 is pivotally connected to the second finger 149. Therefore, if the first finger 147 rotates with respect to the connecting rod 151, the second finger 149 rotates with respect to the connecting rod 153. That is, if the first finger 147 rotates in a clockwise direction with respect to the drawing, the second finger 149 rotates in a counter-clockwise direction, and vice versa, such that the first finger 147 and the second finger 149 cooperatively operate to grasp or release a steering wheel 400 of a vehicle.

A third connecting rod 158 connected, respectively, to the first and second plates 125 and 127, is provided at a side of the first finger 147 such that the third connecting rod 157 can restrict a pivotal motion of the first finger 147. Similarly, a fourth connecting rod 159 connected, respectively, to the first and second plates 125 and 127, is provided at a side of the second finger 149 such that the fourth connecting rod 159 can restrict a pivotal motion of the second finger 149. As shown in FIG. 5, the third connecting rod 158 is positioned to restrict a counter-clockwise rotation (with respect to the orientation of the drawing) of the first finger 147 and the fourth connecting rod 159 is positioned to restrict a counter-clockwise rotation of the second finger 149.

The elastic member 155 provides the first finger 147 with an elastic force, thereby causing it to rotate in a counter-clockwise direction with respect to the drawing. Accordingly, the elastic member 155 biases the first finger 147 so that the first finger 147 and the second finger 149 are in a grasping state. That is, if the elastic member 155 is in a relaxed state the first finger 147 and the second finger 149 are positioned as shown by the dotted line in FIG. 5. If an external force, applied in a direction as shown in the drawing, is transmitted to the first finger 147 by a vehicle crash the elastic member 155 is expanded by the external force so that the first finger 147 rotates in a clockwise direction and the second finger 149 rotates in a counter-clockwise direction. As a result, the hand unit 105 is separated from the steering wheel 400. The hand unit 105 of the arm assembly 100 is provided with the elastic member 155 that elastically biases the first finger 147, therefore, the hand unit 105 can realize a human-like force acting on the first and second fingers 147 and 149.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

In the arm assembly according to the preferred embodiment of the present invention, the lower arm unit is driven by the motor and the gear unit, so that the arm assembly can operate similarly to a human arm. Consequently, damage to a human body can be more accurately determined through a crash test using the arm assembly according to the preferred embodiments of the present invention. Furthermore, because the fingers of the hand unit are elastically biased the hand unit can grasp the steering wheel and release the steering wheel when an external force acts on the fingers. Consequently, the hand unit operates similarly to a human hand.

1. An arm assembly for a crash test dummy, comprising:
an upper arm unit of which an upper portion is connected to a body of a crash test dummy;
a lower arm unit pivotally connected to a lower portion of the upper arm unit;
a wrist joint of which a first end is rotatably connected to the lower arm unit; and
a hand unit pivotally connected to a second end of the wrist joint,
wherein the upper arm unit comprises:
a housing; and
a driving device disposed in the housing for driving the lower arm unit.

2. The arm assembly of claim 1, wherein the driving device comprises:
a motor; and
a gear unit that is driven by the motor, the gear unit configured to drive the lower arm unit to undergo pivotal motions.

3. An arm assembly for a crash test dummy comprising:
an upper arm unit of which an upper end portion is connected to a body of a crash test dummy;
a lower arm unit pivotally connected to a lower end portion of the upper arm unit;
a wrist joint of which a first end is rotatably connected to the lower arm unit; and
a hand unit pivotally connected to a second end of the wrist joint,
wherein the hand unit is configured to grasp a steering wheel of a vehicle and to be separated from the steering wheel by a force.

4. The arm assembly of claim 3, wherein the hand unit comprises:
a first plate and a second plate that are disposed to face each other;
a first connecting rod coupled respectively to the first and second plates, the wrist joint being pivotally connected to the first connecting rod;
a second connecting rod coupled respectively to the first and second plates such that the second connecting rod restricts pivotal motions of the wrist joint with respect to the first connecting rod;
a first finger unit pivotally coupled to the first and second plates;
a second finger unit pivotally coupled to the first and second plates, and the second finger unit being connected to the first finger unit such that the second finger unit moves together with the first finger unit; and
an elastic member biasing the first finger unit so that the first finger unit and the second finger unit are in a grasping state.

5. The arm assembly of claim 4, wherein the hand unit further comprises a third connecting rod connected respectively to the first and second plates such that the third connecting rod restricts a pivotal motion of the first finger unit.

6. The arm assembly of claim 4, wherein the hand unit further comprises a fourth connecting rod connected respectively to the first and second plates such that the fourth connecting rod restricts a pivotal motion of the second finger unit.

7. The arm assembly of claim 4, wherein the elastic member is a coil spring.

8. An arm assembly for a crash test dummy, comprising:
an upper arm unit connected to a body of the crash test dummy;
a lower arm unit pivotally connected to a lower portion of the upper arm unit;
a wrist joint of which a first end is rotatably connected to the lower arm unit; and
a hand unit rotatably connected to a second end of the wrist joint,
wherein the upper arm comprises:
a housing; and
a driving device disposed in the housing and driving the lower arm unit,
and wherein the hand unit is configured to grasp a steering wheel of a vehicle and to be separated from the steering wheel by a force.

9. The arm assembly of claim 8, wherein the driving device comprises:
a motor; and
a gear unit that is driven by the motor, the gear unit configured to drive the lower arm unit to undergo pivotal motions.

10. The arm assembly of claim 8, wherein the hand unit comprises:
a first plate and a second plate that are disposed to face each other;
a first connecting rod coupled respectively to the first and second plates, the wrist joint being pivotally connected to the first connecting rod;
a second connecting rod coupled respectively to the first and second plates such that the second connecting rod restricts pivotal motions of the wrist joint with respect to the first connecting rod;
a first finger unit pivotally coupled to the first and second plates;
a second finger unit pivotally coupled to the first and second plates, and the second finger unit being connected to the first finger unit such that the second finger unit moves together with the first finger unit; and
an elastic member biasing the first finger unit so that the first finger unit and the second finger unit are in a grasping state.

11. The arm assembly of claim 10, wherein the hand unit further comprises:
a third connecting rod connected respectively to the first and second plates such that the third connecting rod restricts a pivotal motion of the first finger unit; and
a fourth connecting rod connected respectively to the first and second plates such that the fourth connecting rod restricts a pivotal motion of the second finger unit.

12. An arm assembly for a crash test dummy, comprising:
an upper arm unit connected to a body of a crash test dummy;
a lower arm unit pivotally connected to a lower portion of the upper arm unit;
a hand unit; and
a wrist joint connecting the lower arm unit and the hand unit together,
wherein a circular recession is formed on an outer periphery of a first end portion of the wrist joint, a cylindrical recession is formed in the lower arm unit, a circular protrusion is formed along an inner periphery of the cylindrical recession, and the first end of the wrist joint is inserted into the cylindrical recession such that the circular recession is fitted into the circular protrusion.

13. The arm assembly of claim 12, wherein the hand unit comprises a first plate and a second plate that are disposed to face each other, a circular plate having a through hole formed in a center portion thereof is provided in a second end of the wrist joint, the circular plate is disposed between the first and second plates, and the circular plate is connected to the first and second plates through a connecting rod that is rotatably inserted into the through hole.

14. The arm assembly of claim 13, wherein a friction member is disposed between the circular plate of the wrist joint and the first and second plates of the hand unit.
